(19) United States
(12) Patent Application Publication
(10) Pub. No.: US 2007/0201965 A1
(43) Pub. Date: Aug. 30, 2007

(54) Threaded fastening systems

(76) Inventor: Barry Littlewood, Rotherham (GB)

Correspondence Address: SHERIDAN ROSS PC, 1560 BROADWAY, SUITE 1200, DENVER, CO, 80202, US

(21) Appl. No.: 11/365,145

(22) Filed: Feb. 28, 2006

(51) Int. Cl. F16B 13/06

(52) U.S. Cl. 411/46

(57) ABSTRACT

A threaded fastening system for fixing together sections of engineering assemblies that are subject to vibration and impact, comprising a primary male threaded fastener having an axially slotted recess in the threaded end thereof, the recess having a maximum diameter, the axial slots defining segments in the end of the male threaded fastener which can be expanded radially: a generally tapered insert having a minimum diameter less than and a maximum diameter greater than the maximum diameter of said recess into which the recess engages, in use, so as to expand said segments radially; a female threaded fastener surrounding at least a part of said male threaded fastener, whereby, in use, the segments of the male threaded fastener expand radially into the threads of said female threaded fastener as the insert is inserted into the recess, characterised in that one of said recess and said insert is provided with a plurality of transverse, generally parallel, grooves and the other of said recess and said insert is provided with at least one transverse raised lip for engagement in one of said grooves such that, in use, as the insert is inserted into the recess, the raised lip rides progressively over said grooves until the lip locks in one of said grooves thereby resisting self loosening of the fastening system.

### BACKGROUND

When sections of engineering assemblies, that are subject to vibration and impact during operation, are fixed together using male threaded fasteners, which comprise a threaded shank on at least one end, and female counterparts, it is important that there is resistance to self loosening in order to maintain the integrity of the joint.

Under the dynamic loading conditions of operation of engineering assemblies, the external loads can induce movements of the fasteners relative to each other and to the members being clamped. Radial sliding movements created at the fastener thread interfaces can be of the maximum allowed tolerances and occur more often in practice than is admitted resulting in self loosening of the system and the loss of the frictional and pre-loads. In severe cases catastrophic failure occurs as the fasteners become completely separated from each other.

All threaded fasteners subject to vibration eventually self loosen in this manner unless some element of resistance is incorporated.

Improved threaded fastening systems are described in United Kingdom patent numbers GB2341654B and GB2341655B, in which a tapered insert is used to expand the end of a male threaded fastener into locking contact with a female threaded element screwed thereon. However, even in these improved systems, it is possible that self loosening may occur so necessitating an improved locking arrangement.

### SUMMARY OF INVENTION

It is an object of the present invention to provide an improved threaded fastening system in which self loosening is better resisted than in the systems of prior art. Preferably, required pre-loads can be maintained under dynamic loading conditions of operation by seeking to ensure that radial sliding movements at the thread interfaces are eliminated and the fasteners are locked in position unable to self loosen rotationally.

According to the invention there is provided a threaded fastening system for fixing together sections of engineering assemblies that are subject to vibration and impact, preferably resisting self loosening by locking the fasteners in position while maintaining a required pre-load at the interface of the sections, the threaded system comprising
a primary male threaded fastener having an axially slotted recess in a threaded end thereof, the recess having a maximum diameter, the axial slots defining segments in the end of the male threaded fastener which can be expanded radially;
a generally tapered insert having a minimum diameter less than and a maximum diameter greater than the maximum diameter of said recess into which the insert engages, in use, so as to expand said segments radially:
a female threaded fastener surrounding at least a part of said male threaded fastener,
whereby, in use, the segments of the male threaded fastener expand radially into the threads of said female threaded fastener as the insert is inserted into the recess,
characterised in that one of said recess and said insert is provided with a plurality of generally parallel grooves and the other of said recess and said insert is provided with at least one raised lip for engagement in one of said grooves such that, in use, as the insert is inserted into the recess, the raised lip rides progressively over said grooves until the lip locks in one of said grooves thereby resisting self loosening of the fastening system.

### BRIEF DESCRIPTION OF THE DRAWINGS

Preferred embodiments of the invention will now be more particularly described, by way of example only, with reference to the accompanying drawings, in which:

FIG. 1 is a view of a square section tapered insert and square section tapered recess showing abutment, wide angle collar and recess, lips, grooves and slots as described.

FIG. 2 shows the insert fully engaged in the recess of the fastening system in a closed threaded bore, with bore of increased outer dimension at the forward end, where the secondary male threaded fastener has a hexagon head.

FIG. 3 is a section of the system through the insert and recess showing the engagement of the lip in the groove.

FIG. 4 shows a section of the fastening system where the female counterpart is a nut.

FIG. 5 shows a section of the system where the insert has a threaded stem and is activated by the rotation of a nut on the stem against the hex head of the primary male threaded fastener.

FIG. 6 indicates that provided the insert is not allowed to rotate on its axis, when in the recess, it does not have to be of the same basic geometric configuration as the recess. In this diagram the insert is of square section taper but the recess has basically parallel faces.

FIG. 7 is the reverse of FIG. 6 whereby the insert has parallel faces but the recess is tapered.

FIG. 8 shows how an engineer's stud can be modified at both ends utilising the fastening system described.

FIG. 9 shows the modified engineers stud where the secondary fastener has a hexagon head and a threaded end which locates in the insert in the threaded bore of the clamped assembly component.

FIGS. 10, 11, 12 and 13 show sections and plans of various types of insert with different anti-rotational devices.

FIGS. 14, 15, 16, and 17 show other types of inserts and recesses.

FIGS. 18, 19, 20 show some different arrangements of lips and grooves that can be used to vary the ease with which locking and unlocking takes place.

FIG. 21 shows exploded view of the primary male and open female fastener before the insert is engaged in the recess.

FIG. 21a is a plan view of the segments and flexure hinge positions.

FIG. 22 shows the insert tightened into the recess.

FIG. 22a shows a plan view of the segments and flexure hinge positions after expansion of the threaded end has taken place. The original positions are shown as dotted lines.

FIG. 23 shows the securing system with a raised hexagon drive insert with axially directed lips to engage with the axially directed grooves of the recess.

FIG. 24 shows the insert and recess from FIG. 23 locked in position giving the same overall effect as in FIG. 22.

FIG. 25 is a view of the insert and recess when the insert is composed of two pieces.

FIG. 26 shows a different geometric form of insert and recess.

FIG. 27 is a graph showing how the bolt strain varies along its axis when a nut is tightened onto it in a clamping situation.

FIG. 28 shows how the information from FIG. 27 can be applied when open fasteners of different heights are used.

FIG. 29 shows an example of the insert and recess without their threaded portions.

### DETAILED DESCRIPTION

Throughout the description and claims of this specification the words “comprise” and “contain” and variation of the words, for example “comprising” and “comprises”, means “including but not limited to”, and is not intended to (and does not) exclude other components, integers or steps.

Throughout the description and claims of this specification, the singular encompasses the plural unless the context otherwise requires. In particular, where the indefinite article is used, the specification is to be understood as contemplating plurality as well as singularity unless the context requires otherwise.

Features, integers, characteristics, or groups described in conjunction with a particular aspect, embodiment or example of the invention are to be understood to be applicable to any other aspect, embodiment or example described herein unless incompatible therewith.

In relation to a recess or insert of non-circular cross section, the “diameter” means the maximum dimension of the cross section.

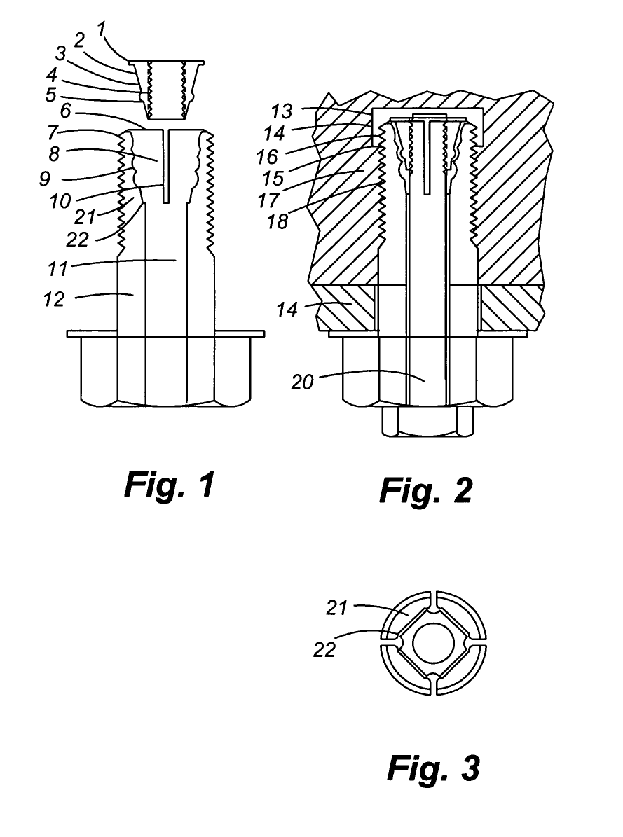

FIG. 1 is a view of the modified primary threaded fastener (12) and the insert (3) which fits into the recess (8) in the threaded end of the fastener (12). The primary fastener (12) shown is a hex head bolt although any other fasteners such as set screws, socket cap screws, engineers studs, wheel studs and threaded rod could be used.

Into the threaded end of the primary fastener (12), which is specially prepared to allow it to be easily deformed, is introduced a recess (8), which is normally tapered, whose section is generally non circular, two of its prime functions being to ensure the insert (3) is unable to be rotated about its axis when in position and is capable of being drawn into the recess (8) by the secondary fastener (20) as described later in FIG. 2. If the recess (8) is tapered the wide end is at the extreme threaded end (6) of the primary fastener (12). There may be a wider angled part (7) of the recess (8) at this position depending on the requirements of the system. Blending in with and extending axially from the forward position of the recess (8) is an axial bore (11) which runs the full length of the primary male threaded fastener (12). In the face of the recess (8), transverse to the axis, are grooves (9), the quantity and profile of which can vary depending on the degree of locking required, which will be discussed later. Axially directed slots (10), originating from the end of the recess (8) at the extreme threaded end (6) of the primary male threaded fastener (12), spaced circumferentially, divide the threaded end of the male fastener (12) into segments (21 ) and create flexure hinge positions between the forward ends of the slots (10) at which the segments (21) bend. The quantity, width and length of the slots (10) can vary depending on such things as the outer diameter of the male fastener (12), the amount of material removed from the recess (8) which affects the remaining wall thickness, the overall resistance to deformation, which varies according to the material from which the fastener (12) is manufactured, and the amount of bending necessary to effect the resistance to self loosening. It is useful, but by no means essential, for the slots (10) to extend no further than the forward position of the end of the recess (8) before it blends into the axial bore (11).

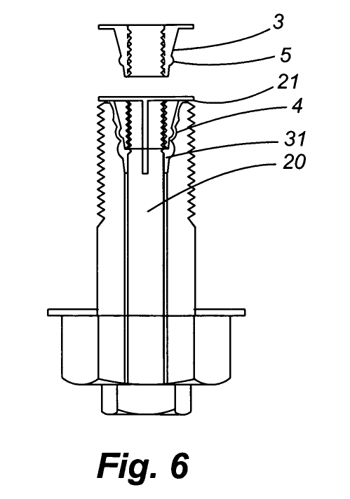

The insert (3), which locates in the recess (8), is usually of the same general form as the recess (8) but can be different provided that during operation it is unable to be rotated about its axis when in the recess (8) while at the same time being able to be pulled into the recess (8), by the secondary fastener (20), as already mentioned and described later (see FIGS. 6,7). At the end of the insert (3) nearest to the extreme threaded end (6) of the primary threaded fastener (12), when inserted in the recess (8), is an optional abutment (1), whose external dimensions are less than the inner diameter of the bore (18) of the female counterpart (17) to allow clamping of the assembly components (17, 19), (see FIG. 2), adjacent an optional wide angled collar (2) depending on the requirements of the system. Transverse to the axis of the insert (3) is at least one raised lip (5) that could be continuous and encircle the face of the insert (3) or could be in several parts. The quantity and profile of the lips (5) can vary depending on the size of the insert (3) and other requirements of the system. A threaded bore (4) is introduced along the axis of the insert (3) from the end opposite the abutment (1) and although it can run the full length it is possible to finish short of the abutment (1) depending on the requirements of the system.

FIG. 2 shows the clamped assembly components (17,19) with the insert (3) fully engaged in the recess (8) by the action of the secondary male threaded fastener (20). The secondary male threaded fastener (20), which in this case is a hex head bolt but could be a set screw or socket cap screw, or any other type of male threaded fastener, has a thread on at least one end which is compatible with the threaded bore (4) of the insert (3). The preferred method of installation is to initially threadedly engage the secondary fastener (20) with the axial bore (4) of the insert (3) from the end opposite the abutment (1) and to rotate the secondary fastener (20) into the insert (3) drawing it into the recess (8), the geometry of the insert (3) and recess (8) being such that the insert (3) does not rotate about its axis when in the recess (8), until the head of the secondary fastener (20) bears against the head of the primary fastener (12). Rotation of the secondary fastener (20) is continued to a position just before the bending and expanding of the segments (21) takes place at the flexure hinge positions (22), due to the presence of the slots (10). This unit of primary male fastener (12) and insert (3) in recess (8) secured by the secondary male fastener (20) is then passed through a suitable washer, if desired, and into the assembly components (17,19) to be clamped. Where the female component (17) has a blind threaded bore (18) it is advantageous, but not essential, to have a bore (13) of greater outer dimension than the outer diameter of the threaded bore (18) beyond its last thread of engagement. The primary male threaded fastener (12) is then torqued to its recommended value, using a suitable wrench, inducing the necessary pre-load. The secondary male fastener (20) is then torqued to its recommended value, against the head of the primary fastener (12), and into the threaded bore (4) of the insert (3).

During this tightening procedure the raised lip (5) of the insert (3) rides over the grooves (9) in the face of the recess (8) and as a result of the respective included angles of the insert (3) and recess (8) and the presence of the slots (10) causes the threads of the segments (21), which because of their preparation are easily deformed, to splay outwards from their flexure hinge positions (22) such that the crests of the threads of the male fastener (12) are forced into the roots of the threads of the female counterpart (17) at the position of the last thread of engagement (15) of the threaded bore (18) in the assembly component (17). As this process continues the wide angled collar (2) of the insert (3) is being forced into the wide angled part (7) of the recess (8) causing further outward expansion of the segments (21) into the larger dimension bore (13) over the forward face at the position of the last thread of engagement (15) until the outer thread diameter of the protruding threads (14) exceeds that of the outer thread diameter of the threaded bore (18) of the clamped component (17) by an increasing amount towards the end of the segments (21) at the extreme threaded end (6) of the primary male fastener (12) and the lip (5) on the face of the insert (3) locks into the appropriate groove (9) in the face of the recess (8). Although the wider angled contact faces (2,7) of the insert (3) and recess (8) are useful and effective they are not vital to the operation of the system.

At this point as the frictional load and calculated pre-load are achieved provided there has been no embedment of any of the component contact faces, the male threaded fastener (12) is unable to rotatably loosen due to it being secured in position by the action of the crests of the protruding threads (14) of the male fastener (12) on the roots of the threads of the bore (18) of the female counterpart (17) at the position of the last thread of engagement (15), and by the action of the outward bending of the protruding threads (14) of the male fastener (12) over the forward face of the larger dimension bore (13) beyond the end of the threaded bore (18) of the female component (17) at this position (15). Also the elimination of the interengagement thread spacings at this position (15) will prevent sliding movements at the threads interface caused by the vibrational force. The locking of the lip (5) of the insert (3) into the appropriate groove (9) of the recess (8) is the final implementation of the extra vibration resisting element. Thus, self loosening during operation will be prevented.

The primary male fastener (12) and female counterpart (17) can be separated, say, for assembly maintenance purposes, by simply reversing the assembly procedures.

FIG. 3 shows a plan view of the flexure hinge positions (22) and segments (21) of a square section tapered insert (3) in a square section tapered recess (8).

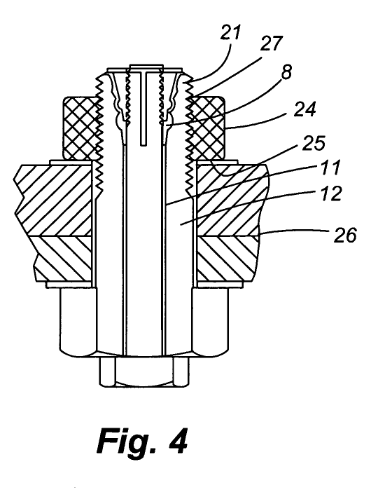

FIG. 4 shows the female fastener to be an open nut (24) although any other form of open fastener can be used. The principle of operation is the same as described in FIGS. 1 and 2 but in this case the expansion of the easily deformed protruding segments (21) at the threaded end of the male threaded fastener (12) takes place at the thread of engagement (27) of the nut (24) with further expansion of the segments (21) taking place over the face of the nut (24) at this position (27). In order to ensure the maximum load generated by the nut (24) is at the maximum tensile stress area of the primary fastener (12) it is useful if the thread of engagement (25) is nearer to the clamped surface (26) than is the end of the recess (8) which blends into the axial bore (11) of the primary male threaded fastener (12). This embodiment is often used if the open female fastener (24) is difficult to access.

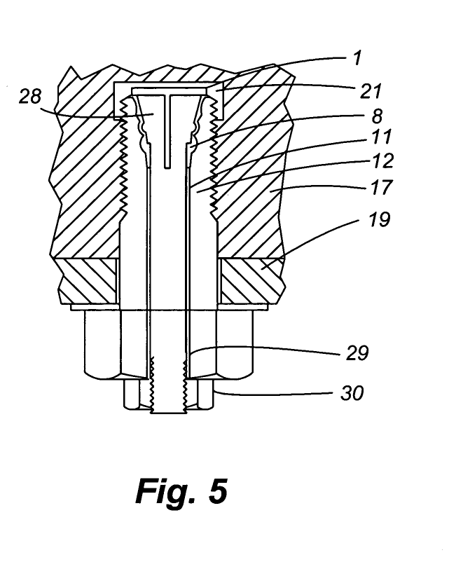

FIG. 5 shows the components (17,19) being clamped by a hex head bolt (12) which as been modified using the system already described. In this case, however, the insert (28) has a threaded stem (29) which extends from the end opposite the abutment (1) and passes through the axial bore (11) of the primary male fastener (12). The insert (28) is drawn into the recess (8) by rotating a nut (30), or other open female fastener, onto the threaded end of the insert stem (29) against the hex head of the primary fastener (12) to a position just before the expansion of the segments (21) begins. The calculated torque is then applied to the head of the primary fastener (12) in order to induce the pre-load. A further calculated torque is then applied to the open female fastener (30) as it is rotated against the head of the primary fastener (12) and the expansion of the segments (21) of the threaded end of the primary male fastener (12), and their subsequent locking by the action of the lipped insert (28) in the grooved recess (8), is as described in FIG. 2.

FIG. 6 shows an example of how the basic geometric form of the insert (3) and recess (31) do not have to be the same provided the insert (3) does not rotate about its axis when in the recess (31) and provided it is capable of being drawn into the recess (31) by the secondary fastener (20) causing the necessary expansion of the segments (21) and the locking of the raised lip (5) of the insert (3) in the appropriate groove (9) of the recess (31). Here the insert (3) is a square section tapered component with a raised transverse lip (5) on the surface of the tapered component but the recess (31) with grooves (9) has basically parallel faces.

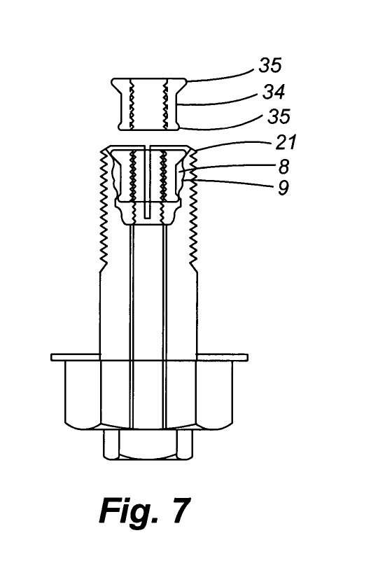

FIG. 7 shows another configuration whereby the insert (34) and recess (8) are not of the same general geometric form. In this case the insert (34) has raised transverse lips (35) and parallel sides but the recess (8) is a square section taper with transverse grooves (9). The expansion of the segments (21) and the locking of the insert (34) in the recess (8) is as already described in FIG. 2.

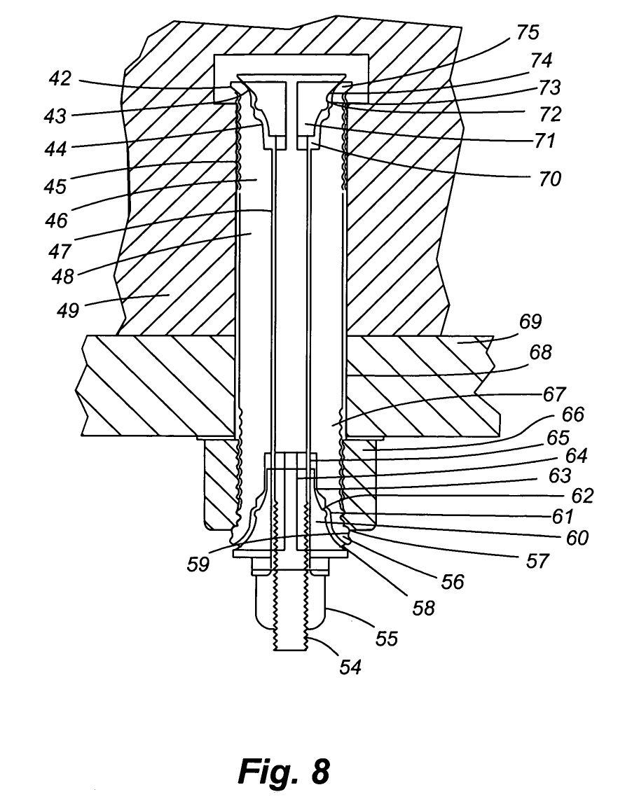

FIG. 8 shows a modified engineers stud (48) that allows one threaded end (46) to be screwed into a threaded bore (45) of an assembly component (49) and the other end (67) to be threadedly engaged by an open threaded bore component, such as a nut (66) that allows an assembly component (69), having a plain bore (68), to be clamped to the component (49) having the threaded bore (45).

The principle of operation is the same as already described whereby segments (75,56) generated by slots (44,64) are caused to expand to diameters greater than the outer diameters of those of their female counterparts (46,66) at the positions of thread engagements (74,57) nearest to the extreme threaded ends of the engineers stud (48) by the movements of the inserts (71,60) into the recesses (70,65) by the secondary fastener component (54) and by the action of the wide angled collars (42,58) of the inserts (71,60) on the wider angled parts (43,59) of the recesses (70,65) until the lips (73,61) of the inserts (71,60) lock into the appropriate grooves (72,62) of the recesses (70,65) eliminating any possibility of rotational loosening during operation.

There is an axial bore (47) along the full length of the stud (48). Introduced into both threaded ends, (46,67), are square sectioned tapered recesses (70,65), the ends of which are treated to allow them to be easily deformed, having slots (44,64) placed circumferentially that divide the recess into segments (75,56) and grooves (72,62) in the faces, as described previously. Into the recess (70) is placed the insert (71) with the threaded stem (54) along the axial bore (47) of the stud (48). The insert (71) must be of such geometry that it is unable to rotate about its axis when in the recess (70) and have a lip (73) on at least one face that contacts with the groove (72) in the recess (70).

Into the recess (65), in which is positioned the threaded stem (54), is placed another insert (60), that has an axial plain bore (63) which again is of such geometric configuration that it is unable to rotate about its axis when in the recess (65) and which has a lip (61) on at least the face that contacts with the groove (62) of the face of the recess (65). A female threaded fastener, such as a nut (55), is then threadedly engaged with the threaded stem (54) to a position just before the segments (75,56) bend and expand outwards. The whole unit comprising stud (48) and inserts (60,71) in recesses (65,70) secured by the female threaded fastener (55) on the threaded end (54) of the stemmed insert (71) is then engaged in the assembly component (49), having the threaded bore (45), to a pre-determined position and the other assembly components (69) having a plain bore (68) placed in position on the stud (48). A female threaded fastener (66) is then engaged with the threaded end (67) of the stud (48) and torqued to its required value. The female threaded fastener (55) engaged with the threaded stem (54) of the insert (71) is then torqued to its pre-determined value. During this tightening procedure the inserts (71,60) are caused to move towards each other into their respective recesses (70,65), the lips (73,61) of the inserts (71,60) riding over the grooves (72,62) of the recesses (70,65), the ends of the threads of the segments (75,56) at both ends of the stud (48) being caused to increase in diameter by the presence of the axial slots (44,64) and the action of the insert collars (42,58) on the easily deformed ends of the segments (75,56) of the stud (48) causing them to bend over the faces of the female counterparts at the interengagement positions (75,57) until the lips (73,61) of the inserts (71,60) lock into the appropriate grooves (72,62) of the recesses (70,65), the interengagement thread spacings at positions (74,52) at the ends of the open and closed counterparts of the male threaded stud (48) being eliminated and self loosening of the fastening system prevented.

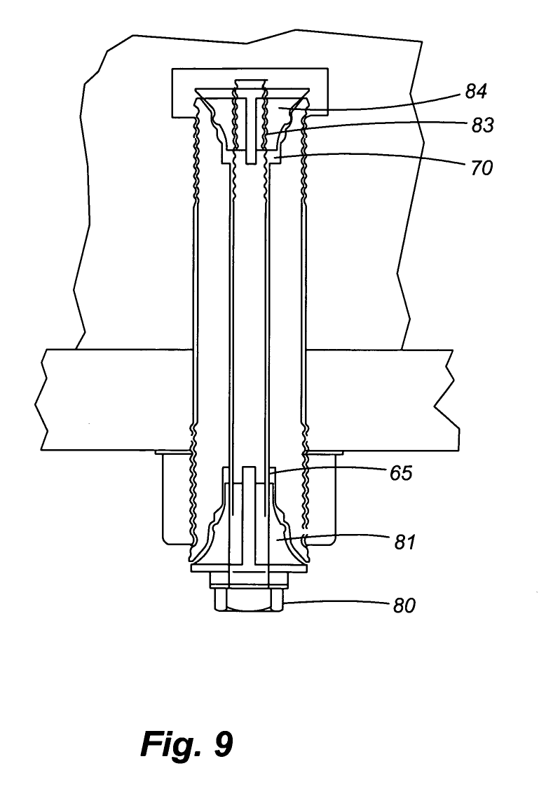

FIG. 9 shows a similar arrangement to FIG. 8 except that the inserts (81,84) are activated in the recess (65, 70) by a secondary fastener having a head (80) and being rotated into the threaded bore (83) of the insert (84). The expansion and locking are as already described.

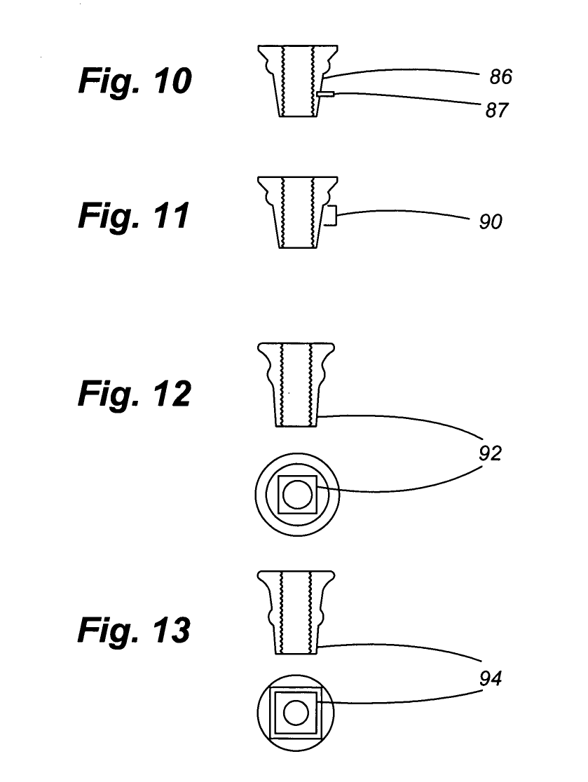

FIG. 10 shows an insert having a different type of anti-rotational device. Here there is at least one pin or dowel (87) located on the insert (86) which fits into the appropriate axial slot of the recess of the primary male fastener.

FIG. 11 shows an arrangement similar to FIG. 10 except that instead of a pin or dowel a fin (90) is utilised instead.

FIGS. 12 & 13 show other forms of anti-rotational device whereby the ends of the inserts (92,94) and those of the axial bore into which they blend are square but could be any non-circular geometric form.

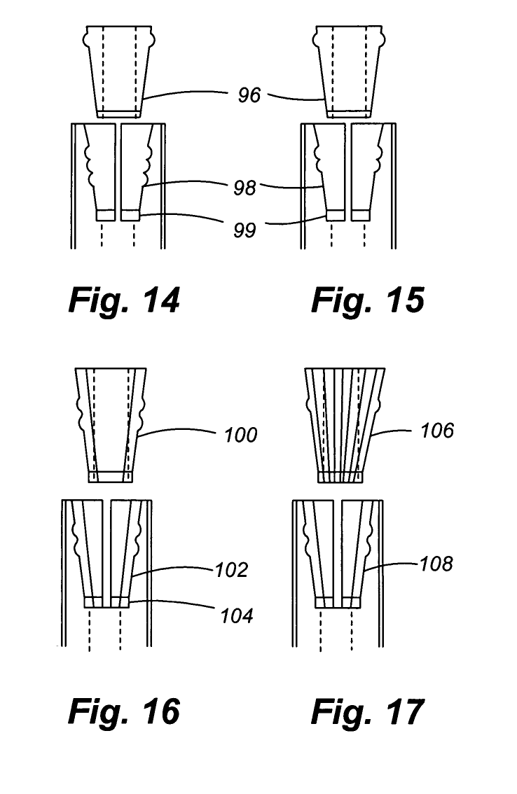

FIGS. 14 & 15 show another configuration of anti-rotational insert (96) and recess (98) with the inserts having neither abutments nor wide angled components. The cross sections could be square with a square section narrow end (99) or could be frusto conical with a square section narrow end.

FIG. 16 shows a hexagonal tapered insert (100) and recess (102) with a square section narrow end (104).

FIG. 17 shows the insert (106) to have a series of axial grooves or flutes to prevent rotation of the insert (106) in the insert (108).

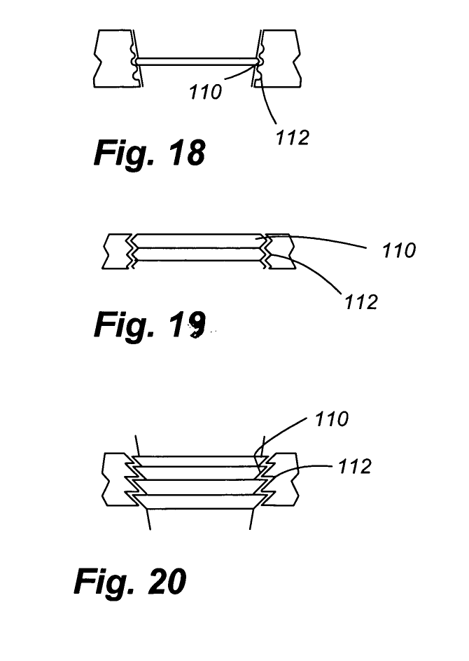

FIGS. 18, 19 & 20 show some different types of lips (110) and grooves (112) that can be used to vary the ease with which locking and unlocking of the insert in the recess takes place.

To those skilled in the art there are many more combinations of developing the techniques described to prevent the insert from rotating in the recess, allowing it to be later locked into position, utilising the ability of the extreme threaded end to be easily deformed as the lips are engaged in the grooves. For example, the inserts could have square, hexagonal, splined or any other geometric form of extension to either or both ends providing the complementary recesses do not allow them to rotate about their axes when located in the recesses.

The examples described here have lips on the inserts and grooves in the recesses but there is no reason why the locations cannot be reversed. The locking effect could also be by means of adhesives at the insert/recess interface.

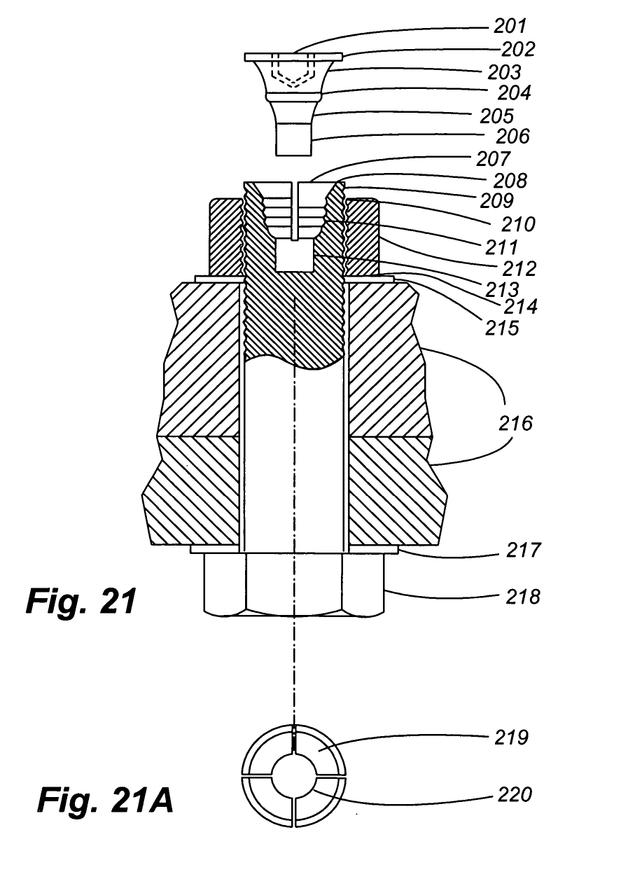

FIG. 21 shows the assemblies (216) to be clamped where the primary male threaded fastener is a hexagon headed bolt (218) although any other male threaded fastener such as a set screw, socket cap screw, wheel stud, engineers stud, threaded rod etc. could be used and the female threaded fastener is a hexagon nut (212) although any other open type fastener could be used. Under the hex head of the male fastener (218) and the open female fastener (212) are showed flat washers (217,215) although these are optional depending on the physical characteristics of the fastening components. The thread length protruding beyond the last thread of engagement (210) of the male fastener can vary depending on the particular requirements of the system.

The insert (205), whose general form is frusto conical, has at its wide end an optional abutment (202) whose external dimensions usually allow the open female fastener (212) to pass over it during installation of the components in the assemblies (216). Adjacent the abutment (202) is a wide angled collar (203) whose included angle is greater than that of the frusto cone, but can vary according to the requirement of the system. Transverse to the axis of the insert (205) is at least one raised lip (204) that could be continuous and encircle the face of the insert (205) or could be in several parts. The quantity and profile of the lips (204) can vary depending on the size of the insert (205) and other requirements of the system. Extending from the narrow end of the insert (205) is a threaded spigot (206) whose dimensions again can vary depending on the size of the insert (205). There is a hexagonal recess (201) at the wide end of the insert (205) which accepts an internal hexagon wrench although this recess could be square, cross, spline etc. As shown in later diagrams the drive could be external such as hexagon, square, spline etc.

The threaded end (208) of the recess (207) is specially prepared by heat treatment or other means to allow it to be easily deformed, the reasons for which will be discussed later, and has an included internal angle wider than the general included angle of the frusto cone which again is useful but not vital to the operation of the system. Blending in with and extending axially from the narrow end of the recess (207) is a threaded bore (213) whose dimensions are compatible with the threaded spigot (206) of the insert (205). In the face of the recess (207), transverse to the axis, are grooves (211), the quantity and profile of which can vary depending on the degree of locking required. Axially directed slots (209), originating from the wide end of the recess (207), spaced circumferentially, divide the threaded end (208) of the male fastener (218) into segments (219) and create flexure hinge positions (220) between the forward ends of the slots (209) at which the segments (219) bend. The quantity, width and length of the slots can vary depending on such things as the outer diameter of the male fastener (218), the amount of material removed from the recess (207), which affects the remaining wall thickness, the overall resistance to deformation which varies according to the material from which the fastener (218) is manufactured and the amount of bending necessary to effect the resistance to self loosening. It is useful, but by no means essential, for the slots (209) to extend no further than the rearward position of the threaded bore (213). If it is required to have the maximum bolt strain at the maximum tensile stress area, after tightening the female fastener onto the male fastener, then the most forward end of the threaded bore of the recess should be rearward of the first thread of engagement (214).

FIG. 21a shows a plan view of the relationship between the segments (219), the flexure hinges (220) and the slots (209).

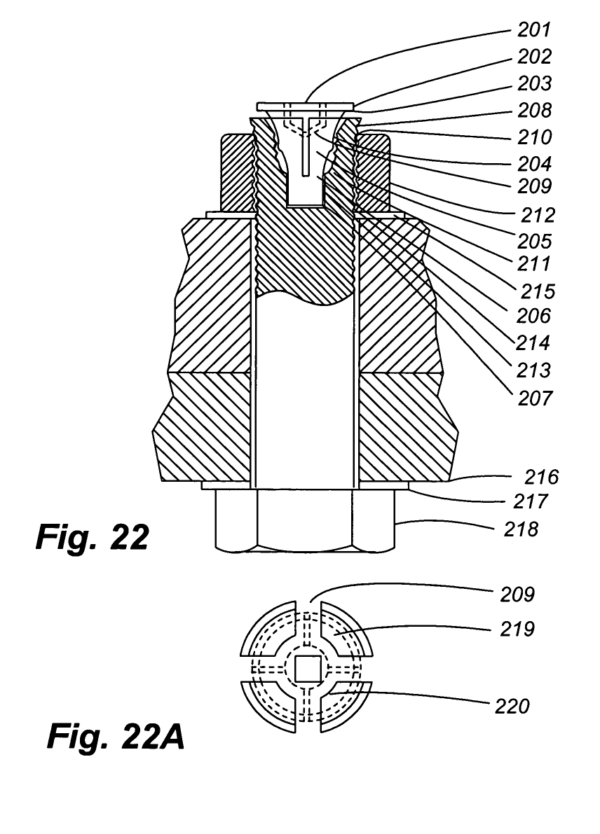

FIG. 22 shows the clamped assemblies (216) with the insert (205) fully engaged in the recess (207). The preferred method of installation of the system is to initially threadedly engage the threaded spigot (206) of the insert (205) in the threaded bore (213) of the recess (207) in the male fastener (218) to a position just before the bending and expanding of the segments (219) takes place. This unit of male fastener (218) and insert (205) has a washer (217) of suitable flatness and hardness placed at the hexagon head end (218) and then passed through the openings (217) of the assemblies (216) to be clamped. The open female fastener (212) is then passed over the abutment (202) of the insert (205) and rotated on to the threads of the male fastener (218), over which has been placed another washer (215) of suitable flatness and hardness, and torqued to its recommended value using a suitable wrench, creating the required pre-load and inducing the necessary extension in the male fastener (218). The insert (205) is then finally torqued into the threaded bore (213) of the recess (207) to its required value using a suitable wrench in the hexagon recess (201) of the insert (205) through the abutment (202).

During this process the raised lip (204), or lips (204) of the insert (205) rides over the grooves (211) in the face of the recess (207) and, as a result of the respective included angles of the basic frusto cones of the insert (205) and recess (207), causes the protruding threads (208) of the segments (219), generated by the slots (209) at the end of the male fastener (218) to splay outwards from the flexure hinge positions (220) such that the crests of the threads of the male fastener 218) are forced into the roots of the threads of the female fastener (212) at the position of the last thread of engagement (210). At the same time as this is happening the wide angled collar (203) of the insert (205) is being forced into the wide angled, easily deformed, protruding threads (208) at the end of the of the recess (207) causing the segments (219) to expand outwards over the rear face of the female fastener until the outer thread diameter exceeds that of the female fastener (212) as the lip (204) on the face of the insert (205) locks into the appropriate groove (211) in the face of the recess (207). Although the rearward wide angles of the insert and recess are useful and effective they are not vital to the operation of the system.

At this point the frictional load and calculated pre-load remain as required, provided there has been no embedment of any of the component contact faces, because the female fastener (212) is unable to rotatably loosen due to it being secured in position by the action of the crests of the protruding threads (208) of the male fastener (218) on the roots of the threads of the female fastener (212) at the position of the last thread of engagement (210) and by the action of the outward bending of the segments (219) of the protruding threads (208) of the male fastener (218) over the rearward end of the female fastener (212). Also the elimination of the interengagement thread spacings at the position of the last threads of engagement (210) of the female fastener (212) will prevent sliding movements at the threads interface caused by the vibrational force. The locking of the lip (204) of the insert (205) into the appropriate groove (211) of the reces (207) is the final implementation of the extra vibration resisting element. Thus, self loosening during operation will be prevented.

The primary male and female fasteners (218,212) can be separated, say, for assembly maintenance purposes, by loosening the insert (205) from the threaded bore (213) of the recess (207) and then rotating the primary female fastener (212) from the primary male fastener (218).

There are many working combinations and permutations of the features described to allow those skilled in the art to prepare the fastening system best required for the specific circumstances.

FIG. 22a shows how a plan view of the male fastener (218) would appear without the insert, after the expansion of the segments has taken place from the flexure hinge positions (220). The widths of the slots (209) are also increased and the original dimensions before expansion are shown as dotted lines.

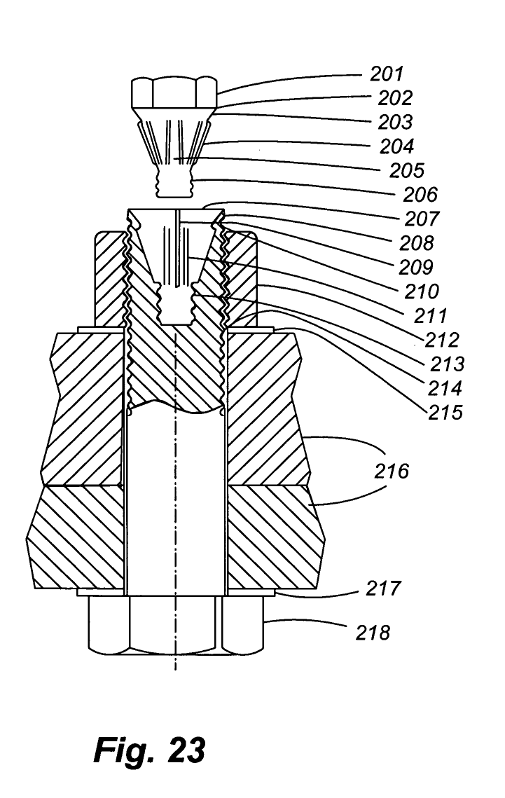

FIG. 23 shows the assemblies (216) to be clamped using a hexagon headed bolt (218), flat washers (215,217) and open hexagon nut (212) whose first thread of engagement (214) is forward of the closed end of the threaded bore (213) of the recess (207) and whose rearward end is sufficiently forward of the specially prepared extreme threaded end (208) of the male fastener (218). The basic forms of insert (205) and recess (207) are frusto conical but in this embodiment, however, the drive (201) of the insert (205) is an external hexagon form whose underside (202) can act as a tightening indicator abutment and the raised lips (204) of the insert (205) and the grooves (211) of the recess (207) are in an axial direction instead of a transverse one but the functions of the driving means (201) and its underside (202), the wide angled collar (203), the raised lips (204) and threaded spigot (206) of the insert (205), the slots (209), wide rearward angle of recess (207), protruding threads of the segments 208), grooves (211) and internal threaded bore (213) of the recess (207) perform the same function in preventing self loosening as described in FIGS. 21 & 22.

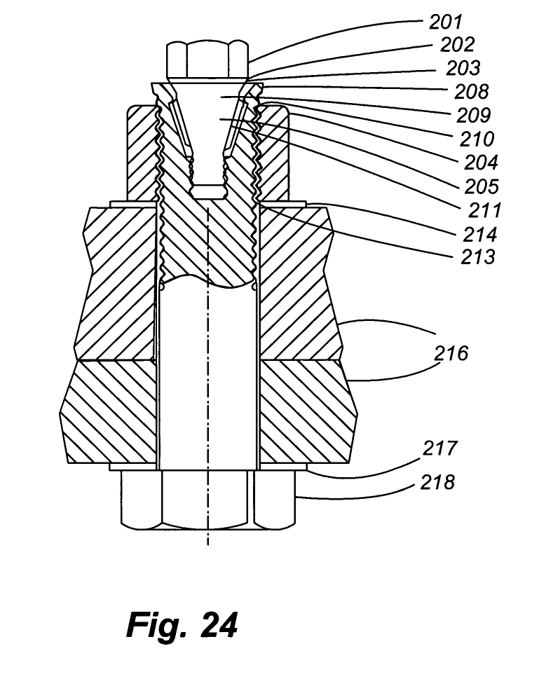

FIG. 24 shows the insert (205) and recess (207) as in FIG. 23 fully engaged with the basic locking system and resistance to self loosening as described in FIGS. 21 & 22.

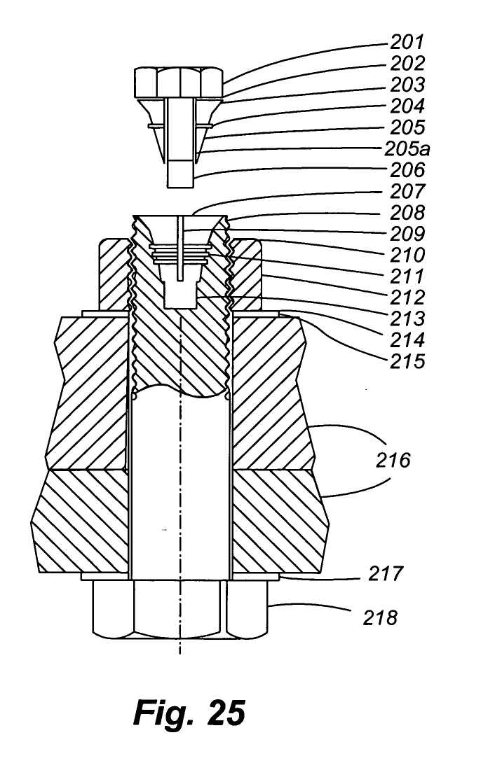

FIG. 25 shows the assemblies (216) to be clamped using a hexagon headed bolt, (218) flat washers (217,215) and open nut (212) whose first thread of engagement (214) is forward of the closed end of the threaded bore (213) of the recess (207) and whose rearward end is sufficiently forward of the specially prepared extreme threaded end (208) of the male fastener (218) to allow it to fulfil its function in preventing rotational loosening of the fasteners (218,212). The basic forms of the insert (205) and recess (207) are frusto conical but the driving means (201), threaded spigot (206) and frusto conical part of insert (205) are in several pieces, in this case two, comprising an external hexagon headed drive (201) with underside (202) acting as a tightening indicator abutment and threaded spigot (206) as one piece and a frusto conical portion (205) with wide rearward angle (203), at least one transverse lip (204) and plain axial bore (205a) through which the spigot extension (206) passes as the other.

The recess (207) comprises the wide angled, specially prepared, rearward end (208), slots (209) generating threaded segments that protrude beyond the rear thread of engagement (210) of the open female fastener (212), transverse grooves (211) and threaded bore (213) which all have the same function as their equivalent components described in FIGS. 21 & 22 in preventing self loosening of the system.

In this embodiment, however, after the locking is complete, the driving means (201) and spigot (206) can be removed while the frusto conical part of the insert (205) remains in the locked position in the threaded end of the male fastener (218) and is used where tamper proof fasteners are necessary.

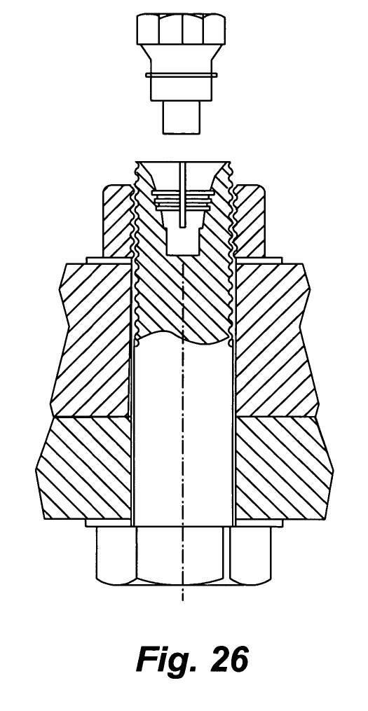

FIG. 26 shows a different form of embodiment but the functions of the numbered parts are the same as those described in FIGS. 21 & 22.

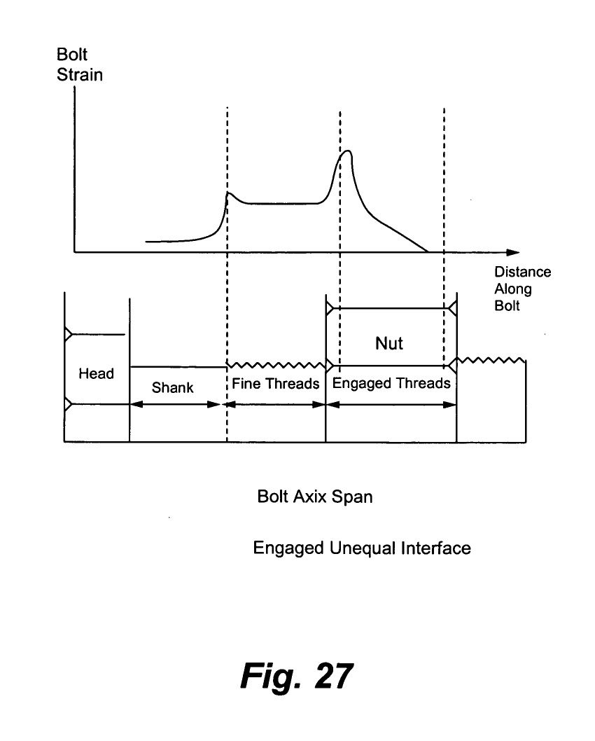

FIG. 27 is a graph showing how the bolt strain varies along its axis when a nut is rotated onto it in a clamping situation.

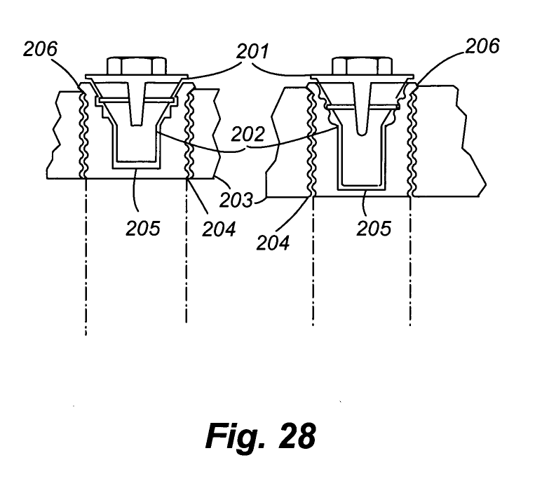

FIG. 28 shows how the results from FIG. 27 can be applied when open fasteners (203) of different heights are used. The included angles of the inserts (201) and recesses (202) vary to ensure the maximum bolt strain occurs towards the first thread of engagement of the open female fastener (203) which is forward of the closed end of the threaded bore (205) of the recess (202) while the last thread of engagement (207) is forward of the end of the specially prepared threaded end of the segments (206). The inserts (201) shown here have an external hexagon headed drive. The functions of the components are as described in FIGS. 21 & 22.

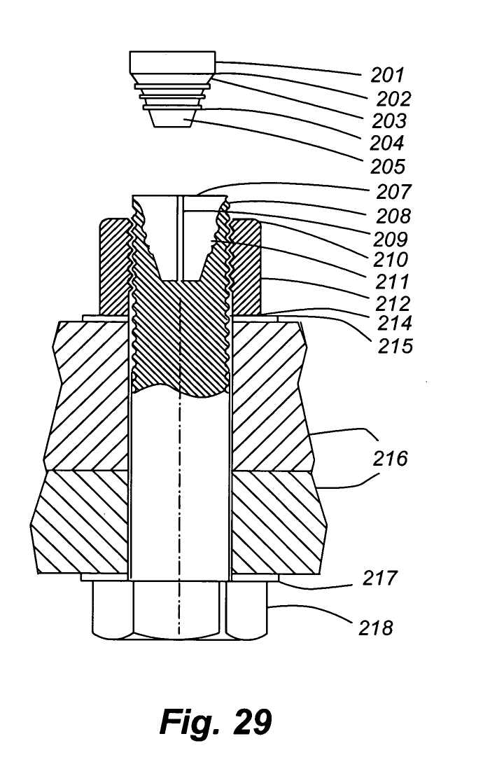

FIG. 29 is a similar clamping arrangement to FIGS. 21 & 22 but the embodiment is different insomuch that although basic frusto conical forms of the insert (205) and recess (207) are similar there is no threaded spigot on the insert (205) and no threaded bore in the recess (207). Before final assembly of the components the insert (205) having at least one transverse raised lip (204) on its face is pressed into the recess (207), having transverse grooves (211), using the driving means (201), to a position just before expansion of the threaded end (208) takes place. The female fastener (212) is then torqued to its required value and the insert (205) further pressed or hammered into the recess (207) until the locking and resistance to self loosening is effected. The functions of the numbered components are as described in FIGS. 21 and 22.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (included any accompanying claims, abstract and drawings) and /or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiments. The invention extends to any novel one, or any novel combination, of the features disclosed in this specification (including any accompanying claims, abstract and drawings), or to any novel one, or any novel combination of the steps of any method or process so disclosed.

The embodiments described are by no means exhaustive of the methods available. The prevention of self loosening of male and open female threaded fasteners can use many combinations and permutations of the principles outlined by those skilled in the art.

1. A threaded fastening system for fixing together sections of engineering assemblies that are subject to vibration and impact, comprising:
a primary male threaded fastener having an axially slotted recess in the threaded end thereof, the recess having a maximum diameter, the axial slots defining segments in the end of the male threaded fastener which can be expanded radially;
a generally tapered insert having a minimum diameter less than and a maximum diameter greater than the maximum diameter of said recess into which the insert engages, in use, so as to expand said segments radially; and
a female threaded fastener surrounding at least a part of said male threaded fastener;
whereby, in use, the segments of the male threaded fastener expand radially into threads of said female threaded fastener as the insert is inserted into the recess, said recess and said insert being provided with a plurality of generally parallel grooves and wherein at least one of said recess and said insert is provided with at least one raised lip for engagement in one of said grooves such that, in use, as the insert is inserted into the recess, the raised lip rides progressively over said grooves until the lip locks in one of said grooves, thereby resisting self loosening of the fastening system.

2. The threaded fastening system as claimed in claim 1, wherein said recess is inwardly-tapered, the angle of taper of said insert being greater than that of the recess into which it engages, in use, so as to expand said segments radially.

3. The threaded fastening system as claimed in claim 1, wherein said grooves and said lip are orientated generally transverse or radially with respect to said recess and insert.

4. The threaded fastening system as claimed in claim 1, wherein said grooves and said lip are orientated generally axially with respect to said recess and insert.

5. The threaded fastening system as claimed in claim 3, wherein said grooves are annular, extending around the circumference of said recess or said insert.

6. The threaded fastening system as claimed in claim 3, wherein said raised lip is annular, extending continuously around the circumference of said recess or said insert.

7. The threaded fastening system as claimed in claim 1, wherein the at least one raised lip is discontinuous.

8. The threaded fastening system as claimed in claim 1, further comprising driving means for driving said insert into said male threaded fastener.

9. The threaded fastening system as claimed in claim 1, wherein the groove in which said lip locks is determined by torque applied to said insert reaching a pre-determined value.

10. The threaded fastening system as claimed in claim 1, wherein the insert has a threaded portion at the narrowest end thereof for engagement with a threaded portion of said recess.

11. The threaded fastening system as claimed in claim 10, wherein said recess and said insert are generally frusto-conical.

12. The threaded fastening system as claimed in claim 10, further comprising driving means for driving said insert into said male threaded fastener, wherein said driving means comprises an appropriate driving instrument for applying torque to said insert in order to screw the threaded portion of said insert into the threaded portion of said recess.

13. The threaded fastening system as claimed in claim 1 wherein said recess and said insert are of non-circular cross-section so as to prevent relative rotation thereof.

14. The threaded fastening system as claimed in claim 13, further comprising driving means for driving said insert into said male threaded fastener, wherein said driving means comprises a threaded rod extending through an axial bore through said primary male fastener to the narrowest part of said insert and into driving engagement therewith.

15. The threaded fastening system as claimed in claim 1, wherein the primary male threaded fastener has a head to which driving force can be applied either externally or internally.

16. The threaded fastening system as claimed in claim 1, wherein the primary male fastener is threaded at both ends and wherein said female fastener comprises a nut acting as a driving head for said primary male fastener.

17. The threaded fastening system as claimed in claim 1, further comprising one or more washers or spacers for axially spacing components of the system.

18. The threaded fastening system as claimed in claim 1, wherein the recess has a further threaded portion at the end thereof furthest away from said segments.

19. The threaded fastening system as claimed in claim 1, wherein the groove in which said lip locks is determined by an axial force applied to said insert reaching a pre-determined value.

20. The threaded fastening system as claimed in claim 1, wherein the insert comprises more than one piece.

21. The threaded fastening system as claimed in claim 1, wherein the insert has a threaded stem at the narrowest end thereof the stem extending through the axial bore of the primary male threaded fastener for engagement with a female threaded fastener.

22. The threaded fastening system as claimed in claim 14, wherein said driving means comprises a male threaded fastener with a head.

23. A threaded fastening system as claimed in claim 14, wherein the female threaded fastener comprises a closed threaded bore having a threaded portion of a first diameter for engagement with said primary male threaded fastener and a second bore of greater diameter than said first diameter.

24. A method of fixing sections of an engineering assembly, comprising,
a) providing a threaded fastening system as set forth in claim 1; and
b) fixing together sections of an engineering assembly using said system.
